(19) United States
(12) Patent Application Publication
(10) Pub. No.: US 2001/0037716 A1
(43) Pub. Date: Nov. 8, 2001

(54) METHOD AND APPARATUS FOR REMOVING ONE OR MORE COVERS OF AN ELECTRONIC MODULE

(76) Inventor: HOWARD L. DAVIDSON, SAN CARLOS, CA (US)

Correspondence Address: B NOEL KIVLIN, CONLEY ROSE & TAYON, PO BOX 398, AUSTIN, TX, 787670398

(21) Appl. No.: 09/211,612

(22) Filed: Dec. 15, 1998

(51) Int. Cl. B26D 1/16; B26D 1/18

(52) U.S. Cl. 83/872; 83/56

(57) ABSTRACT

A method and apparatus are presented for removing one or more covers of an electronic module. The electronic module includes a cover extending over semiconductor devices mounted upon a substantially planar surface of the substrate. The cover is attached to the surface of the substrate about the semiconductor devices by an adhesive layer. The method includes bringing a cutting blade into contact with the cover and the adhesive layer such that the adhesive layer and a portion of the cover adjacent to the adhesive layer are substantially removed. During the cover removal procedure, a bottom surface of the cutting blade may be moved in a plane parallel to the substantially planar surface of the substrate. One embodiment of the apparatus includes a cutting tool having a cutting blade, a base plate, and a fixture adapted for holding the module. During use, the module may be held within the fixture, the fixture may be secured to the base plate, and a desired distance may be established and maintained between the bottom surface of the cutting blade and the substantially planar surface of the substrate.

### BACKGROUND OF THE INVENTION

1. Field of the Invention

This invention relates to sealed electronic modules, and more particularly to the removal of covers of sealed electronic modules wherein the covers are attached to surfaces of substrates by adhesive layers.

2. Description of the Related Art

Many semiconductor devices include an integrated circuit secured within a protective device package. The integrated circuit includes electronic devices formed upon and within a semiconductor substrate. During operation the electronic devices dissipate electrical power, transforming electrical energy into heat energy. Several key operating parameters of the electronic devices typically vary with temperature, and reliable device operation within specifications occurs only within defined operating temperature ranges. For high performance semiconductor devices, such as microprocessors, specified performance is only achieved when semiconductor device temperatures are maintained below specified maximum operating temperatures. Operation of a semiconductor device at a temperature above the maximum operating temperature may result in irreversible damage. In addition, it has been established that the reliability of a semiconductor device decreases with increasing operating temperature. The heat energy produced by a semiconductor device during operation must thus be removed to the ambient environment at a rate which ensures operational and reliability requirements are met.

As integrated circuit fabrication technology improves, manufacturers are able to reduce the dimensions of electronic devices. Such dimension reductions not only allow more electronic devices to be integrated onto semiconductor substrates, they also allow the electronic devices to operate at faster rates while dissipating less electrical power. Unfortunately, the reduction in power dissipation is typically not proportional to the reduction in physical size, and the increased number of electronic devices operating at faster rates end up dissipating more electrical power. As a result, more complex heat transfer (i.e., cooling) mechanisms are often required to maintain semiconductor devices including high density integrated circuits at temperatures below maximum operating temperatures.

FIG. 1 is an isometric view of an electronic module 10 including several semiconductor devices 12 coupled to an upper surface of a substrate 14. Heat energy is removed from semiconductor devices 12 by liquid immersion cooling. Substrate 14 may be, for example, a fiberglass-epoxy printed circuit board, or a ceramic substrate including electrically conductive signal traces. Electronic module 10 also includes a top cover 16 and a bottom cover 18. Top cover 16 has a cavity 20 formed in an underside surface and dimensioned to encompass semiconductor devices 12. A first adhesive layer 22 attaches a lip of top cover 16 about cavity 20 to a portion of the upper surface of substrate 14 surrounding semiconductor devices 12. Adhesive layer 22 seals the interface between top cover 16 and substrate 14. Adhesive layer 22 may be formed from, for example, a thermosetting adhesive which becomes substantially rigid following a curing process (e.g., an epoxy resin). Bottom cover 18 has a cavity 24 formed in an upper surface. A second adhesive layer similar to adhesive layer 22 attaches a lip of bottom cover 18 about cavity 24 to a portion of an underside surface of substrate 14 directly opposite top cover 16 as shown in FIG. 1. The second adhesive layer seals the interface between bottom cover 18 and substrate 14.

Cavity 20 of top cover 16 and the upper surface of substrate 14 form a first chamber in which semiconductor devices 12 reside. Similarly, cavity 24 of bottom cover 18 and the underside surface of substrate 14 form a second chamber. The first and second chambers may be joined by one or more holes extending between the upper and underside surfaces of substrate 14. The first and second chambers may be substantially filled with a fluid (e.g., silicone oil) which transfers heat energy from surfaces of semiconductor devices 12 to top cover 16 and bottom cover 18 by natural convection.

Alternately, the first and second chambers may be filled with an evaporative fluid (e.g., a fluorocarbon liquid) such that semiconductor devices 12 are immersed in the fluid. The evaporative fluid may absorb heat energy from semiconductor devices 12 as it transitions from a liquid state to a vapor state at a boiling temperature. The vapor may condense on interior surfaces of cavity 20, transferring the absorbed heat energy to top cover 16. Further, a flow of a liquid (e.g., a fluorocarbon liquid) may be established between ports (not shown) in top cover 16 and/or bottom cover 18. The liquid may flow through the joined first and second chambers and absorb the heat energies of semiconductor devices 12.

Electronic module 10 may occasionally need to be partially disassembled to allow access to semiconductor devices 12 for, for example, failure analysis and replacement of a malfunctioning semiconductor device. FIGS. 2a-g will now be used to describe a current “module rework” process during which top cover 16 and bottom cover 18 are detached from substrate 14. FIG. 2a is a side elevation view of electronic module 10 during a first step in the current module rework process. During the first step, heat produced by a heat source 30 is directed at first adhesive layer 22 in order to soften adhesive layer 22.

First adhesive layer 22 may be a thermosetting adhesive (e.g., an epoxy resin) having a glass transition temperature above which the material becomes soft and pliable. In this case, sufficient heat may be applied to raise the temperature of first adhesive layer 22 above the glass transition temperature.

Following the softening of first adhesive layer 22 by heating, top cover 16 is detached from substrate 14 by rotation. FIG. 2b is a side elevation view of electronic module 10 illustrating the rotation of top cover 16 about an axis 32 perpendicular to the major surfaces of substrate 14 and passing substantially through the center of top cover 16. Bottom cover 18 and/or substrate 14 may be held in a fixed position while top cover 16 is rotated about axis 32. As a result of this rotation, first adhesive layer 22 is broken, detaching top cover 16 from substrate 14. A portion of first adhesive layer 22 remains on the lip of top cover 16. FIG. 2c is a side elevation view of electronic module 10 following the detachment of top cover 16 from substrate 14 by rotation which breaks first adhesive layer 22, leaving a remainder 34 of first adhesive layer 22 upon the upper surface of substrate 14 surrounding semiconductor devices 12.

Following the detachment of top cover 16 from substrate 14, bottom cover 18 is detached from substrate 14 in a similar manner. FIG. 2d is a side elevation view of electronic module 10 illustrating the heating of a second adhesive layer 36 which attaches the lip of bottom cover 18 about cavity 24 to the underside surface of substrate 14 as described above. Second adhesive layer 36 may be a thermosetting adhesive similar to first adhesive layer 22. Heat produced by heat source 30 is directed at second adhesive layer 36 in order to soften second adhesive layer 36.

Following the softening of second adhesive layer 36 by heating, bottom cover 18 is detached from substrate 14 by rotation. FIG. 2e is a side elevation view of electronic module 10 illustrating the rotation of bottom cover 18 about an axis 38 perpendicular to the major surfaces of substrate 14 and passing substantially through the center of bottom cover 18. Substrate 14 may be held in a fixed position while bottom cover 18 is rotated about an axis 38. As a result of this rotation, second adhesive layer 36 is broken, detaching bottom cover 18 from substrate 14. A portion of second adhesive layer 36 remains on the lip of bottom cover 18. FIG. 2f is a side elevation view of electronic module 10 following the detachment of bottom cover 18 from substrate 14 by rotation which breaks second adhesive layer 36, leaving a remainder 40 of second adhesive layer 36 upon the underside surface of substrate 14.

Following the detachments of top cover 16 and bottom cover 18 from substrate 14, the remainders of the first and second adhesive layers clinging to substrate 14 are removed. Such removal may be accomplished mechanically by scraping, filing, or sanding. FIG. 2g is a side elevation view of electronic module 10 following the detachments of top cover 16 and bottom cover 18 from substrate 14 and removal of remainders 34 and 40 of respective first adhesive layer 22 and second adhesive layer 36. Semiconductor devices 12 are now suitably accessible for, for example, failure analysis and replacement of a malfunctioning semiconductor device.

The current module rework process described above is not only tedious and time consuming, the risk of physical damage to semiconductor devices 12 during the module rework process is relatively high. Success of the module rework process depends greatly upon the skill of the person carrying out the process. Semiconductor devices 12 are often struck and damaged by top cover 16 during detachment of top cover 16 form substrate 14. The semiconductor devices adjacent to comers of cavity 20 are often damaged during rotation of top cover 16 in order to break adhesive layer 22. It takes a certain amount of skill and manual dexterity to remove top cover 16 without damaging semiconductor devices 12. It would thus be desirable to have a module rework process which can be completed in less time than the current process, reduces the risk of physical damage to semiconductor devices 12, and does not depend heavily upon the skill of the person carrying out the process.

### SUMMARY OF THE INVENTION

The problems outlined above are in large part solved by a method and apparatus for removing one or more covers of an electronic module. The electronic module includes one or more semiconductor devices (e.g., integrated circuits) mounted upon a substantially planar surface of a substrate (e.g., a printed circuit board), and a cover which extends over the semiconductor devices and is attached to the surface of the substrate about the semiconductor devices by an adhesive layer. The cover may be removed by bringing a cutting blade into contact with the cover and the adhesive layer such that the adhesive layer and a portion of the cover adjacent to the adhesive layer are substantially removed. Lacking structural support, a remaining portion of the cover separates from the module. During the cover removal procedure, a bottom surface of the cutting blade may be moved in a plane parallel to the substantially planar surface of the substrate.

The substrate may include electrically conductive traces formed upon or within a dielectric material. The substrate may be, for example, a printed circuit board or a ceramic substrate including electrically conductive signal traces. The cover may be formed from a substantially rigid material (e.g., a metal such as aluminum). The adhesive layer preferably includes a material in a substantially rigid state. The material may have been transformed to the substantially rigid state via a curing process. For example, the material may be a thermosetting material (e.g., an epoxy resin) which has been transformed to the substantially rigid state via subjection to heat.

One embodiment of an apparatus for removing the cover of the electronic module includes a cutting tool having a cutting blade, a base plate, and a fixture adapted for holding the module. The electronic module may be positioned within the fixture, and the fixture may be secured to the base plate. A desired distance may be established and maintained from the bottom surface of the cutting blade to the substantially planar surface of the substrate.

The fixture may include a pair of moveable jaws biased toward one another and adapted for frictionally grasping an exterior surface of the module (e.g., sides of a bottom cover). Alternately, the fixture may include multiple pins extending outwardly from a main body. The pins may be adapted for insertion into holes in the substrate. When the pins are inserted into the holes in the substrate and the fixture secured to the base plate, the surface of the substrate may be maintained substantially parallel to, and the fixed distance from, the planar surface of the base plate.

The module-containing fixture may be secured to the base plate such that the surface of the substrate is substantially parallel to, and a first distance from, the planar surface of the base plate. A second distance may be established from the bottom surface of the cutting blade to the surface of the base plate, the second distance exceeding the first distance by the desired distance. The cutting blade may then be brought into contact with the cover such that the desired distance remains substantially constant and the adhesive layer and a portion of the cover adjacent to the adhesive layer are substantially removed.

The positioning of the module may include attaching a fixture to the module and securing (e.g., clamping) the fixture to the base plate such that the surface of the substrate is substantially parallel to, and the first distance from, the planar surface of the base plate. The establishing of the second distance may include adjusting the position of the cutting blade relative to the surface of the base plate such that the second distance is achieved, then fixing the position of the cutting blade relative to the surface of the base plate such that the second distance is maintained.

During the cutting operation, the cover may be held in a fixed position, and the cutting blade may be moved in relation to the cover. Alternately, the cutting blade may be held in a fixed position, and the cover may be moved in relation to the cutting blade. In order to ensure that the cutting blade does not contact the substrate, the second distance may be made greater than or equal to the sum of the first distance and a maximum allowable amount of warp in the substrate.

The cutting blade may have a curved outer surface including a cutting surface. The cutting blade may be substantially cylindrical, or the cutting blade may be a cutting disk. During use, the cutting blade may be rotated about an axis passing through circular top and bottom surfaces of the cutting blade.

### BRIEF DESCRIPTION OF THE DRAWINGS

Other objects and advantages of the invention will become apparent upon reading the following detailed description and upon reference to the accompanying drawings in which:

FIG. 1 is an isometric view of an electronic module including several semiconductor devices coupled to an upper surface of a substrate, a top cover enveloping the semiconductor devices and attached to a portion of the upper surface of the substrate about the semiconductor devices by a first adhesive layer, and a bottom cover attached to an underside surface of the substrate directly opposite the top cover by a second adhesive layer;

FIG. 2a is a side elevation view of the electronic module of FIG. 1 during a first step in a current module rework process wherein heat produced by a heat source is directed at the first adhesive layer in order to soften the first adhesive layer;

FIG. 2b is a side elevation view of the electronic module of FIG. 2a during a second step in the module rework process wherein the top cover is rotated in relation to the remainder of the module, resulting in the breaking of the first adhesive layer and detachment of the top cover from the substrate;

FIG. 2c is a side elevation view of the electronic module of FIG. 2b following the detachment of the top cover from the substrate, wherein a remainder of the first adhesive layer exists upon the upper surface of the substrate;

FIG. 2d is a side elevation view of the electronic module of FIG. 2c during a step in the module rework process wherein heat produced by the heat source is directed at the second adhesive layer in order to soften the second adhesive layer;

FIG. 2e is a side elevation view of the electronic module of FIG. 2d during a step in the module rework process wherein the bottom cover is rotated in relation to the remainder of the module, resulting in the breaking of the second adhesive layer and detachment of the bottom cover from the substrate;

FIG. 2f is a side elevation view of the electronic module of FIG. 2e following the detachment of the bottom cover from the substrate, wherein the remainder of the first adhesive layer exists upon the upper surface of the substrate, and wherein a remainder of the second adhesive layer exists upon the underside surface of the substrate;

FIG. 2g is a side elevation view of the electronic module of FIG. 2f following removal of the remainders of the first and second adhesive layers;

FIG. 3a is a side elevation view of the electronic module of FIG. 1 positioned within a first fixture according to the present invention, wherein the first fixture is used to hold the module in place while the top cover is removed, and wherein the first fixture includes a pair of moveable jaws and a biasing mechanism which urges the jaws toward one another;

FIG. 3b is a side elevation view of the electronic module of FIG. 3a undergoing a first cover removal process according to the present invention, wherein during the first cover removal process a cutting tool is used to remove the top cover and the first adhesive layer from the module;

FIG. 3c is a side elevation view of the electronic module of FIG. 3b following the removal of the top cover and the first adhesive layer;

FIG. 3d is a side elevation view of the electronic module of FIG. 3c, minus the top cover and the first adhesive layer, following attachment of a second fixture to the substrate, wherein pins of the second fixture are inserted into corresponding holes in the substrate;

FIG. 3e is a side elevation view of the electronic module of FIG. 3d following detachment of the first fixture from the module and the inversion of the module with the attached second fixture, wherein the module is undergoing a second cover removal process during which the cutting tool is used to remove the bottom cover and the second adhesive layer from the module;

FIG. 3f is a side elevation view of the electronic module of FIG. 3e following removal of the bottom cover and the second adhesive layer;

FIG. 4 is a side elevation view of the electronic module of FIG. 1 illustrating the physical relationship between the substrate, having an allowable warp “w”, and the first and second adhesive layers having thicknesses “t”; and

FIG. 5 is a side elevation view of an alternate embodiment of the electronic module of FIG. 1 positioned within an alternate embodiment of the first fixture and undergoing a cover removal process during which the top cover and the first adhesive layer are removed from the module during a single cutting operation.

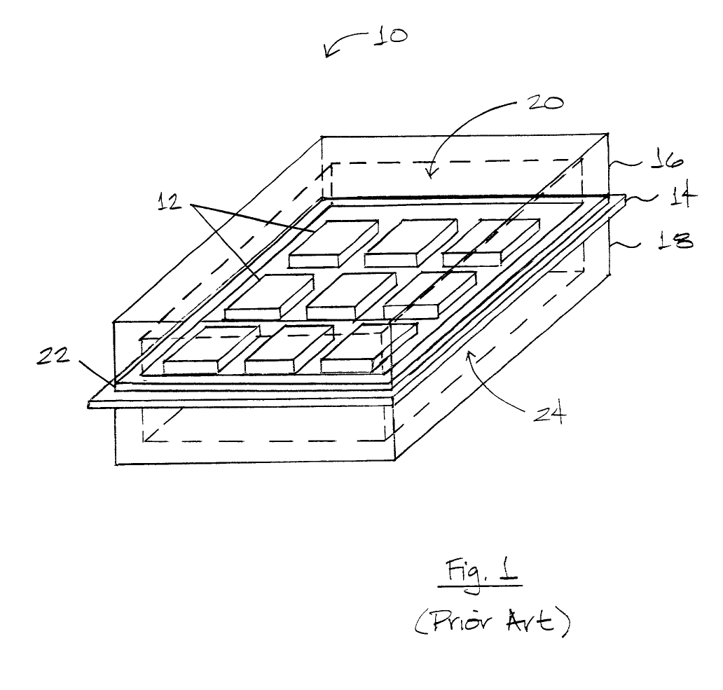

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

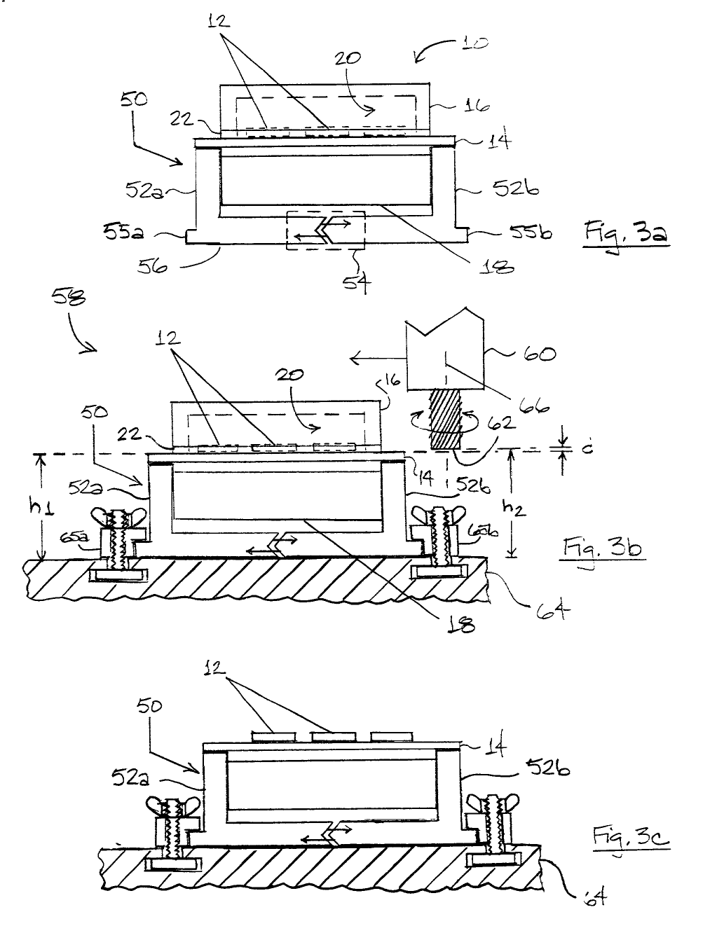

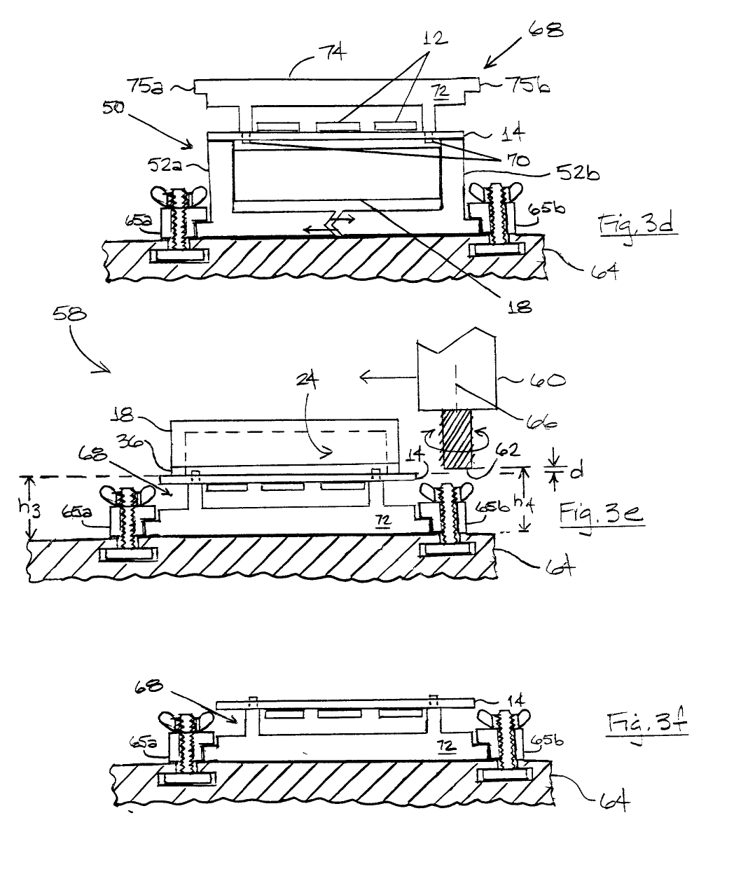

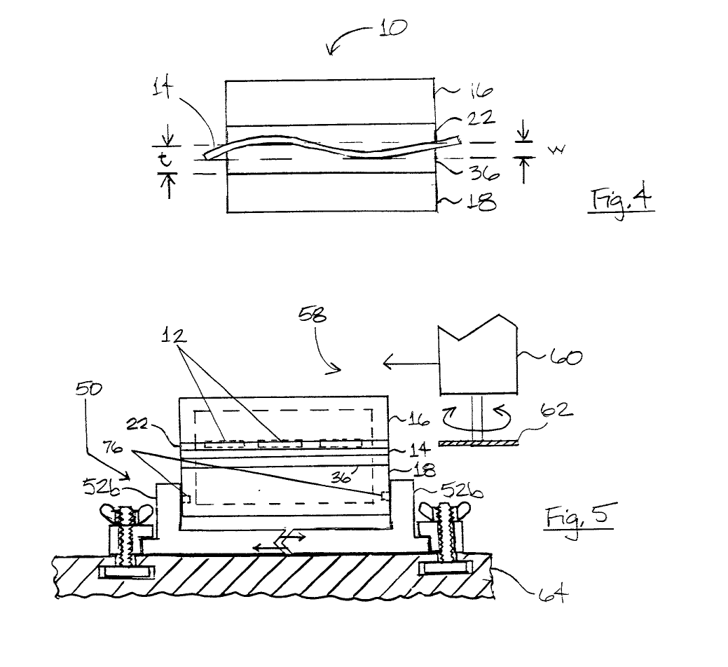

FIGS. 3a-c will now be used to describe an apparatus and method for removing top cover 16 of electronic module 10 in accordance with the present invention. FIG. 3a is a side elevation view of electronic module 10 positioned within a first fixture 50. Fixture 50 is used to hold module 10 in place while top cover 16 is removed. Fixture 50 includes a pair of moveable jaws 52a-b and a biasing mechanism 54. Biasing mechanism 54 urges jaws 52a-b toward one another. Facing inner surfaces of jaws 52a-b may be adapted for frictionally grasping exterior surfaces of module 10 (e.g., opposite sides of bottom cover 18) as shown in FIG. 3a. Optionally, the facing inner surfaces of jaws 52a-b may have protrusions (e.g., ridges or pins) extending therefrom which fit into corresponding recesses (e.g., grooves or holes) in the exterior surfaces of module 10. (See FIG. 5). Biasing mechanism 54 may include a resilient member (e.g., a spring, a rubber band, etc.) or a screw which, when turned, varies the distance between jaws 52a-b.

Jaws 52a-b have upper surfaces which may contact a portion of the underside surface of substrate 14 protruding from the sides of module 10 when module 10 is positioned within fixture 50. Fixture 50 may have a planar underside surface 56 as shown in FIG. 3a. In alternate embodiments, fixture 50 may have three or more legs (not shown) extending downwardly from underside surface 56. Jaw 52a may have a protrusion 55a extending outwardly in a lateral direction from a side of jaw 52a as shown in FIG. 3a. Protrusion 55a may be used for clamping fixture 50 to a planar surface. Protrusion 55a may be a ridge extending an entire length of the side of jaw 52a, or may be a tongue jutting out from a portion of the side of jaw 52a. Jaw 52b may have a similar protrusion 55b extending outwardly in a lateral direction from a side of jaw 52b as shown in FIG. 3a.

FIG. 3b is a side elevation view of electronic module 10 positioned within fixture 50 and undergoing a first cover removal process during which top cover 16 and adhesive layer 22 are removed from module 10. The cover removal process may be carried out using a removal apparatus 58. In addition to fixture 50 for holding module 10 in place, removal apparatus 58 includes a cutting tool 60. Cutting tool 60 includes a cutting blade 62 and a base plate 64 having a planar surface.

During use of removal apparatus 58, a distance d may be established and maintained from a bottom surface of cutting blade 62 to the upper surface of substrate 14 adjacent to top cover 16. For example, underside surfaces of protrusions 55a-b may be placed in contact with the planar surface of base plate 64 as shown in FIG. 3b. Fixture 50 may be secured (i.e., clamped) to the planar surface of base plate 64 such that the upper surface of substrate 14 is substantially parallel to, and a fixed distance “h₁” from, the planar surface of base plate 64. As shown in FIG. 3b, a clamp 65a may be used to clamp protrusion 55a of jaw 52a to the planar surface of base plate 64, and a clamp 65b may be used to clamp protrusion 55b of jaw 52b to the planar surface of base plate 64.

Cutting blade 62 may be substantially cylindrical as shown in FIG. 3b. Such cylindrical cutting blades are called “end mills”. Alternately, cutting blade 62 may be a cutting disk. (See FIG. 5). Such cutting disks are called “slitting saws”. A curved outer surface of cutting blade 62 may comprise a cutting surface. During use, cutting blade 62 may be rotated (e.g., by cutting tool 60) about an axis 66 passing through a top and bottom surfaces of cutting blade 62. Such cutting tools are called “spindles”.

Cutting blade 62 may be positioned with respect to base plate 64 such that a distance “h₂” exists between the bottom surface of cutting blade 62 and the planar surface of base plate 64. Distance h₂ may be selected such that distance h₂ exceeds distance h₁ by distance d.

In order to remove top cover 16 and adhesive layer 22 from module 10, cutting tool 60 is activated, and cutting blade 62 is brought into contact with top cover 16 and adhesive layer 22. Such contact may be achieved by fixing the position of fixture 50 and moving cutting blade 62 in a lateral direction toward module 10. Alternately, the position of cutting blade 62 may be fixed base plate 64, with fixture 50 clamped thereto, may be moved in a lateral direction toward cutting blade 62.

Contact between cutting blade 62 and top cover 16 and adhesive layer 22 results in the removal of relatively small pieces (i.e., chips) of top cover 16 and adhesive layer 22. Cutting tool 60 preferably operates via computer numerical control (CNC), and rotates cutting blade 62 at a relatively high rate of speed (e.g., between about 20,000 RPM and approximately 100,000 RPM) such that most of the heat produced by the cutting is captured in the chips. Contact between cutting blade 62 and top cover 16 is continued until adhesive layer 22 and a portion of top cover 16 adjacent to adhesive layer 22 are substantially removed. Lacking structural support, the uncut remainder of top cover 16 separates from module 10. It is noted that top cover 16 is destroyed during the cutting operation. During the cutting operation, distance d may be maintained substantially constant by maintaining distances h₁ and h₂ substantially constant. As a result, cutting blade 16 never contacts substrate 14. FIG. 3c is a side elevation view of electronic module 10 positioned within fixture 50 following the removal of top cover 16 and adhesive layer 22.

FIGS. 3d-f will now be used to describe an apparatus and method for removing bottom cover 18 of electronic module 10 in accordance with the present invention. FIG. 3d is a side elevation view of electronic module 10, minus top cover 16 and adhesive layer 22, following attachment of a second fixture 68 to substrate 14. Fixture 68 replaces fixture 50 as the fixture of removal apparatus 58 used to hold electronic module 10 in place during the cutting operation. Electronic module 10 may remain positioned within fixture 50 as shown during the attachment of fixture 68 to substrate 14.

In the embodiment of FIGS. 3d-f, substrate 14 has several holes extending between the upper and underside surfaces. The holes are preferably located in the portion of the upper surface of substrate 14 surrounding semiconductor devices 12. For example, substrate 14 may be rectangular. In this case, substrate 14 has four comers, and may have a hole extending between the upper and underside surfaces in each comer.

Fixture 68 includes several pins 70 extending outwardly from a main body 72. Each pin is adapted for insertion into a corresponding hole in substrate 14. Each pin may fit snugly within the corresponding hole, helping retain the pin within the hole. Each pin may also include other mechanical means for retaining the pin within the hole.

Main body 72 of fixture 68 may have a planar surface 74 opposite pins 70 as shown in FIG. 3d. In alternate embodiments, fixture 68 may have three or more legs (not shown) extending outwardly from planar surface 74. Main body 72 may have a pair of protrusions 75a-b extending outwardly in lateral directions from opposite sides of main body 72 as shown in FIG. 3d. Protrusions 75a-b may be used for clamping fixture 50 to a planar surface. Protrusions 75a-b may be ridges extending an entire length of the corresponding sides of main body 72, or may be tongues jutting out from portions of the corresponding sides of main body 72.

Pins 70 are inserted into the corresponding holes in substrate 14. Clamps 65a and 65b are released and fixture 50 separated from base plate 64. Module 10 with fixture 68 attached is inverted and placed upon the planar surface of base plate 64 such that protrusions 75a-b are in contact with the planar surface of base plate 64. Where fixture 68 includes planar surface 74, planar surface 74 may be placed in contact with the planar surface of base plate 64. Fixture 50 may be removed from the remainder of module 10.

During use of removal apparatus 58, distance d may be established and maintained from the bottom surface of cutting blade 62 to the underside surface of substrate 14 adjacent to bottom cover 18. For example, fixture 68 may be secured (i.e., clamped) to the planar surface of base plate 64 such that the underside surface of substrate 14 is substantially parallel to, and a fixed distance “h₃ ” from, the planar surface of base plate 64. Clamps 65a-b may be used to clamp respective protrusions 75a-b to the planar surface of base plate 64.

FIG. 3e is a side elevation view of electronic module 10 held within fixture 68 and undergoing a second cover removal process during which bottom cover 18 and adhesive layer 36 are removed from module 10. During the removal process, the underside surface of substrate 14 remains substantially parallel to, and fixed distance h₃ from, the planar surface of base plate 64. Cutting blade 62 is positioned with respect to base plate 64 such that a distance “h₄ ” exists between the bottom surface of cutting blade 62 and the planar surface of base plate 64. Distance h₄ may be selected such that distance h₄ exceeds distance h₃ by distance d.

In order to reduce the number of times cutting blade 62 must be positioned with respect to base plate 64, fixtures 50 and 68 may be fabricated such that distance hi is substantially equal to distance h₃. In this case, distance h₂ may be equal to distance h₄, and cutting blade 62 may not need to be repositioned between the removal of top cover 16 and the removal of bottom cover 18.

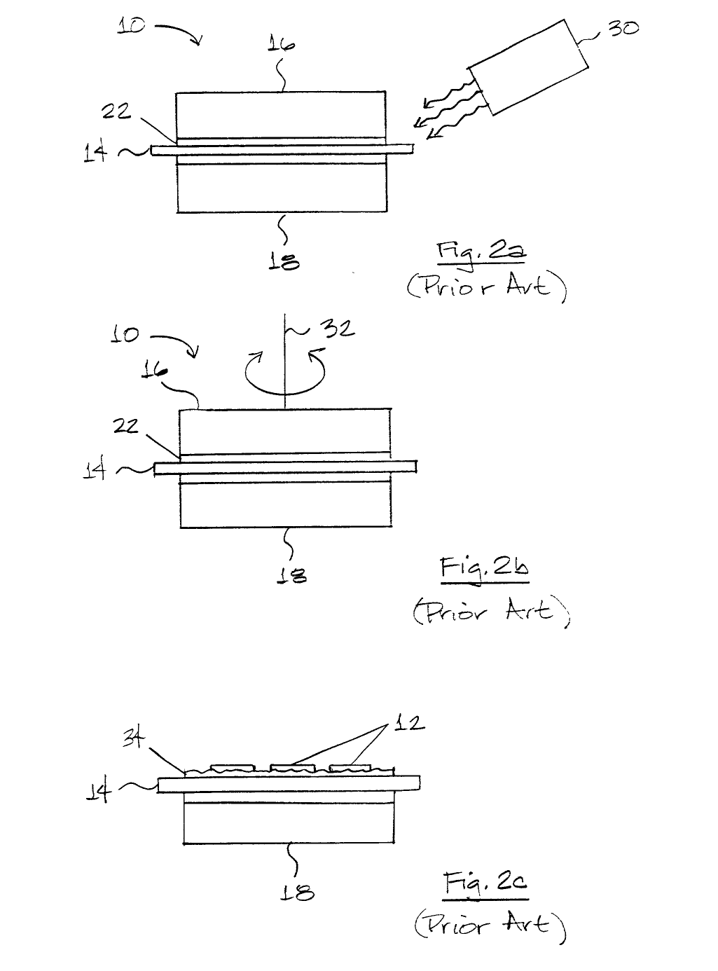

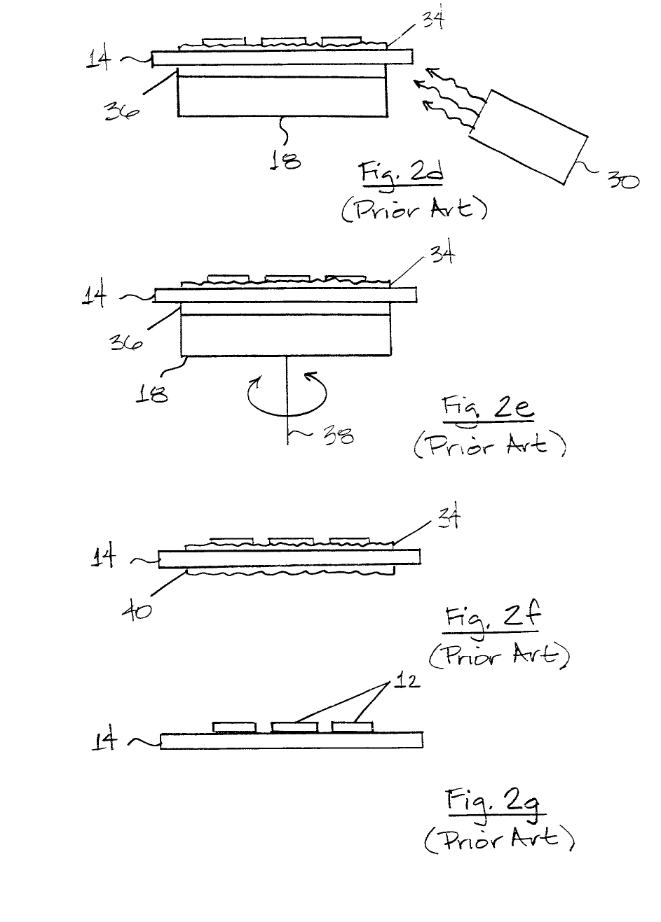

As shown in FIGS. 2d -e and described above, adhesive layer 36 attaches the lip of bottom cover 18 about cavity 24 to the underside surface of substrate 14. In order to remove bottom cover 18 and adhesive layer 36 from the remainder of module 10, cutting tool 60 is activated, and cutting blade 62 is brought into contact with bottom cover 18 and adhesive layer 36. Such contact may be achieved by fixing the position of fixture 68 and moving cutting blade 62 in a lateral direction toward module 10. Alternately, the position of cutting blade 62 may be fixed and base plate 64, with fixture 68 clamped thereto, may be moved in a lateral direction toward cutting blade 62.

Contact between cutting blade 62 and bottom cover 18 and adhesive layer 36 results in the removal of relatively small pieces of bottom cover 18 and adhesive layer 36. Such contact is continued until adhesive layer 36 and a portion of bottom cover 18 adjacent to adhesive layer 36 are substantially removed. Lacking structural support, the uncut remainder of bottom cover 18 separates from module 10. It is noted that bottom cover 18 is destroyed during the cutting operation. During the cutting operation, distance d may be maintained substantially constant by maintaining distances h₃ and h₄ substantially constant. As a result, cutting blade 62 never contacts substrate 14.

FIG. 3f is a side elevation view of the remainder of electronic module 10 attached to fixture 68 following the removal of bottom cover 18 and adhesive layer 36. Following the removal of bottom cover 18 and adhesive layer 36, clamps 65a-b may be released, fixture 68 separated from base plate 64, and substrate 14 detached from fixture 68. Semiconductor devices 12 are now accessible for, for example, failure analysis and replacement of a malfunctioning semiconductor device.

FIG. 4 is a side elevation view of electronic module 10 illustrating the physical relationship between substrate 14 having an allowable warp “w” and adhesive layers 22 and 36 having thicknesses “t”. Warp w is present in both the upper and underside surfaces of substrate 14. A typical value for w is about 10 mils (0.01 inch). In order to prevent cutting blade 62 from contacting substrate 14 during a cutting operation, distance d is selected to be greater than or equal to w. Starting thicknesses t of adhesive layers 22 and 36 are preferably selected to be at least twice the value of w to ensure sufficient clearance between cutting blade 62 and substrate 14 during the cutting operations.

FIG. 5 is a side elevation view of an alternate embodiment of electronic module 10 positioned within an alternate embodiment of fixture 50 and undergoing a cover removal process during which top cover 16 and adhesive layer 22 are simultaneously removed from module 10. In the alternate embodiment of electronic module 10 shown in FIG. 5, exterior edges of substrate 14 are flush with sides of top cover 16 and bottom cover 18. In the alternate embodiment of fixture 50 shown in FIG. 5, the facing inner surfaces of jaws 52a-b have pins 76 which extend into corresponding holes in exterior surfaces of bottom cover 18. In the alternate embodiment of removal apparatus 58 shown in FIG. 5, cutting blade 62 is a cutting disk.

It is noted that fixtures 50 and 68 may have features (e.g., keys) which allow them to be removed from base plate 64 and later replaced in the same position. Jaws 52a-b of fixture 50 and clamps 65a-b may be automatically operated (e.g. electrically, pneumatically, hydraulically, etc.) under the control of an operator or a control unit.

Removal apparatus 58 may also include a mechanism for catching the uncut remainders of the covers separated from the module during the removal operation. For example, a pneumatically-operated suction cup at the end of an arm may be attached to a cover being removed after a significant portion of the cutting has been accomplished. Alternately, the operator may use a vacuum wand to catch the uncut remainders of the covers.

Numerous variations and modifications will become apparent to those skilled in the art once the above disclosure is fully appreciated. It is intended that the following claims be interpreted to embrace all such variations and modifications.

What is claimed is:

1. A method for removing a cover of an electronic module, wherein the cover is attached to a substantially planar surface of a substrate by an adhesive layer, the method comprising:
establishing a distance from a bottom surface of a cutting blade to the substantially planar surface of the substrate; and
bringing the cutting blade and the cover into contact such that the distance remains substantially constant and the adhesive layer and a portion of the cover adjacent to the adhesive layer are substantially removed.

2. The method as recited in claim 1, further comprising:
attaching a fixture to the module; and
securing the fixture to a base plate.

3. The method as recited in claim 1, wherein the establishing comprises:
adjusting the position of the cutting blade relative to the substantially planar surface of the substrate such that the distance is achieved; and
fixing the position of the cutting blade relative to the substantially planar surface of the substrate such that the distance is maintained.

4. The method as recited in claim 1, wherein during the bringing the cutting blade and the cover into contact, the cover is held in a fixed position and the cutting blade is moved in relation to the cover.

5. The method as recited in claim 1, wherein during the bringing the cutting blade and the cover into contact, the cutting-blade is held in a fixed position and the cover is moved in relation to the cutting blade.

6. The method as recited in claim 1, wherein the distance is greater than or equal to an amount of warp in the substrate.

7. A method for removing a cover of an electronic module, wherein the cover is attached to a substantially planar surface of a substrate by an adhesive layer, the method comprising:
bringing a cutting blade into contact with the cover and the adhesive layer such that the adhesive layer and a portion of the cover adjacent to the adhesive layer are substantially removed.

8. The method as recited in claim 7, wherein said cutting blade has a bottom surface, and wherein during the bringing the cutting blade into contact with the cover, the bottom surface if the cutting blade is moved in a plane parallel to the substantially planar surface of the substrate.

9. An apparatus for removing a cover of an electronic module, wherein the cover is attached to a planar surface of a substrate by an adhesive layer, the apparatus comprising:
a cutting tool comprising a cutting blade and a base plate having a substantially planar surface;
a fixture adapted for holding the module; and
wherein during use, the fixture is secured to the base plate such that the surface of the substrate is substantially parallel to, and a fixed distance from, the substantially planar surface of the base plate.

10. The apparatus as recited in claim 9, wherein the cover is formed from a substantially rigid material.

11. The apparatus as recited in claim 10, wherein the cover is formed from a metal.

12. The apparatus as recited in claim 11, wherein the cover is formed from aluminum.

13. The apparatus as recited in claim 9, wherein the adhesive layer comprises a material in a substantially rigid state.

14. The apparatus as recited in claim 13, wherein the material has been transformed to the substantially rigid state via a curing process.

15. The apparatus as recited in claim 14, wherein the material is a thermosetting material which has been transformed to the substantially rigid state via subjection of the material to heat.

16. The apparatus as recited in claim 9, wherein the substrate comprises electrically conductive traces formed upon or within a-dielectric material.

17. The apparatus as recited in claim 16, wherein the substrate is a printed circuit board.

18. The apparatus as recited in claim 9, wherein the cutting blade is substantially cylindrical and has a curved outer surface comprising a cutting surface, and wherein during use the cutting blade is rotated about an axis passing through a top and bottom surfaces of the cutting blade.

19. The apparatus as recited in claim 9, wherein the cutting blade is a cutting disk having a curved outer surface comprising a cutting surface, and wherein during use the cutting blade is rotated about an axis passing through a top and bottom surfaces of the cutting blade.

20. The apparatus as recited in claim 9, wherein the fixture comprises a pair of moveable jaws biased toward one another and adapted for frictionally grasping an exterior surface of the module.

21. The apparatus as recited in claim 9, wherein the substrate has a plurality of holes extending therethrough, and wherein the fixture comprises a plurality of pins extending outwardly from a main body, and wherein each of the plurality of pins is adapted for insertion into a corresponding member of the plurality of holes.
